(19) United States
(12) Patent Application Publication
(10) Pub. No.: US 2026/0053220 A1
(43) Pub. Date: Feb. 26, 2026

(54) HEADBAND WITH MOUNTABLE ELECTRONICS

(71) Applicant: Vuzix Corporation, West Henrietta, NY (US)

(72) Inventors: Tyler W. Porter, Honeoye Falls, NY (US); Erik Zelbacher, Pittsford, NY (US)

(21) Appl. No.: 19/105,866

(22) PCT Filed: Jun. 27, 2023
(86) PCT No.: PCT/US2023/069169

§ 371 Date: Feb. 24, 2025

Related U.S. Application Data
(60) Provisional application No. 63/374,126, filed on Aug. 31, 2022.

(51) Int. Cl. A41D 20/00; A41D 27/00

(52) U.S. Cl. CPC A41D 20/00; A41D 27/00

(57) ABSTRACT

A three-piece headband including a first strap, a second strap, and a third strap. The first strap includes a first end and a second end with at least a portion of the first end and second end including respective internal passageways. During use, the first strap is arranged to engage with the user's forehead and the second and third straps are arranged at least partially within the respective internal passageways of the first strap. The second strap can include a non-elastic portion and an elastic portion and may be arranged to include a connector at one end. The third strap can include a first portion and a second portion, wherein the first portion and/or the second portion is arranged to engage with the connector and secure the headband to the user's head in a tightened state.

### CROSS-REFERENCE TO RELATED APPLICATIONS

This application claims the benefit under Articles 4 and 8 of the Stockholm Act of the Paris Convention for the protection of Industrial Property of U.S. Patent Application No. 63/374,126, filed on Aug. 31, 2022, which application is incorporated by reference in its entirety.

### TECHNICAL FIELD

The present disclosure generally relates to headbands, and more particularly, to headbands for securing electronic devices to a user's head.

### BACKGROUND

Head-Mounted Displays (HMDs), which can take the monocular form of a suspended eyepiece, can include an image source and, in some examples, an image light guide for presenting virtual images to a wearer's eyes. The image light guides can be arranged for conveying the virtual images from an offset position of the image source to a position aligned with the wearer's eye. For many applications, there is particular value in forming a virtual image that can be visually superimposed over the real-world image that lies in the field of view of the HMD user.

HMDs require a mounting device for mounting the display and various other electronics, for example a battery, to the user's head. However, current systems for mounting HMDs fail to suitably secure the electronics to the user's head in a comfortable manner for extended periods of use.

### SUMMARY

The present disclosure is directed to one or more exemplary embodiments of a three-piece headband including a first strap, a second strap, and a third strap. The first strap includes a first end and a second end with at least a portion of the first end and second end including respective internal passageways. During use, the first strap is arranged to engage with the user's forehead and the second and third straps are arranged at least partially within the respective internal passageways of the first strap. The second strap can include a non-elastic portion and an elastic portion and may be arranged to include a connector at one end. The third strap can include a first portion and a second portion, wherein the first portion and/or the second portion is arranged to engage with the connector and secure the headband to the user's head in a tightened state.

The present disclosure is directed to one or more exemplary embodiments of a headband.

In an exemplary embodiment, the headband may comprise a first strap, including a first end comprising a first passageway, a second end comprising a second passageway, a first opening arranged on, in, along, or proximate to the first end, and a second opening arranged on, in, along, or proximate to the second end, a second strap connected to the first strap, the second strap arranged at least partially through the first passageway and the first opening, and a third strap connected to the first strap, the third strap arranged at least partially through the second passageway and the second opening, wherein the third strap is operatively arranged to selectively connect to the second strap.

In an exemplary embodiment, the first strap further comprises a first temple portion, a second temple portion, and a forehead portion arranged between the first temple portion and the second temple portion, wherein the first opening is arranged on, in, along, or proximate to the first temple portion. In an exemplary embodiment, the first passageway and the second passageway are connected forming a single passageway. In an exemplary embodiment, the forehead portion comprises a first height, the first temple portion comprises a second height, and the first height is less than the second height. In an exemplary embodiment, the second strap comprises a third end fixedly secured to the first strap, and a fourth end. In an exemplary embodiment, the third end is arranged in the first passageway. In an exemplary embodiment, the fourth end is connected to a connector.

In an exemplary embodiment, a portion of the second strap engaged with the first opening forms a first loop. In an exemplary embodiment, the first loop is movable between a loosened state and a tightened state. In an exemplary embodiment, a portion of the third strap engaged with the second opening forms a second loop. In an exemplary embodiment, the second strap comprises an elastic portion, and a non-elastic portion. In an exemplary embodiment, the non-elastic portion is engaged with the first opening. In an exemplary embodiment, the third strap comprises a hook fastener section, and a loop fastener section. In an exemplary embodiment, the headband further comprises at least one clip arranged on at least one of the second strap and the third strap, the at least one clip operatively arranged to slidingly or pivotably secure an electronic device to the headband.

The present disclosure is directed to one or more exemplary embodiments of a headband for mounting one or more electronic devices.

In an exemplary embodiment, the headband may comprise a first strap, including a first end comprising a first passageway, a second end comprising a second passageway, a first opening arranged on, in, along, or proximate to the first end, and a second opening arranged on, in, along, or proximate to the second end, a second strap including a third end and a fourth end, the third end fixedly secured to the first strap, the second strap arranged at least partially through the first passageway and the first opening to form a first loop, and a third strap including a fifth end and a sixth end, the fifth end fixedly secured to the first strap, the third strap arranged at least partially through the second passageway and the second opening to form a second loop, wherein the third strap is operatively arranged to be adjustably connected to the second strap to form a secured state of the headband.

In an exemplary embodiment, the first strap further comprises a first temple portion, a second temple portion, and a forehead portion arranged between the first temple portion and the second temple portion, wherein the first opening is arranged on, in, along, or proximate to the first temple portion and the second opening is arranged on, in, along, or proximate to the second temple portion. In an exemplary embodiment, the second strap is slidingly engaged with the first passageway to move the first loop between a first loosened state and a first tightened state. In an exemplary embodiment, the third strap is slidingly engaged with the second passageway to move the second loop between a second loosened state and a second tightened state. In an exemplary embodiment, the second strap comprises a non-elastic portion arranged proximate the third end, and an elastic portion arranged proximate the fourth end. In an exemplary embodiment, the elastic portion extends out of the first passageway past the first end.

These and other aspects, objects, features, and advantages of the present disclosure will be more clearly understood and appreciated from the following detailed description of the embodiments and appended claims, and by reference to the accompanying drawing figures.

### BRIEF DESCRIPTION OF THE DRAWING FIGURES

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1A is a top front perspective view of a headband, in a secured state, according to an exemplary embodiment of the presently disclosed subject matter.

FIG. 1B is a bottom rear perspective view of the headband shown in FIG. 1A.

FIG. 1C is a top plan view of the headband shown in FIG. 1A.

FIG. 2A is a front elevational view of the headband shown in FIG. 1A, in an unsecured state.

FIG. 2B is a rear elevational view of the headband shown in FIG. 2A.

FIG. 2C is a front elevational view of a portion of the headband shown in FIG. 2A.

FIG. 2D is a rear elevational view of another portion of the headband shown in FIG. 2A.

FIG. 2E is a rear elevational view of still another portion of the headband shown in FIG. 2A.

FIG. 3 is a top front perspective view of a headband, in an unsecured state, according to an exemplary embodiment of the presently disclosed subject matter.

FIG. 4 is a top front perspective view of the headband shown in FIG. 3, in a partial disassembled state.

FIG. 5 is a top perspective view of the headband shown in FIG. 3, showing a first loop in a loosened state.

FIG. 6 is a top perspective view of the headband shown in FIG. 3, showing a second loop in a loosened state.

FIG. 7A is a left side elevational view of the headband shown in FIG. 3, in a secured state.

FIG. 7B is a right side elevational view of the headband shown in FIG. 3, in a secured state.

FIG. 8 is a bottom rear perspective view of a headband, according to an exemplary embodiment of the presently disclosed subject matter.

FIG. 9 is a top rear perspective view of the headband shown in FIG. 8.

FIG. 10 a front elevational view of the headband shown in FIG. 8.

FIG. 11 is a front elevational view of a portion of a headband according to an exemplary embodiment of the presently disclosed subject matter.

FIG. 12 is a front elevational view of a portion of a headband according to an exemplary embodiment of the presently disclosed subject matter.

FIG. 13 is a front elevational view of a portion of a headband according to an exemplary embodiment of the presently disclosed subject matter.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Where used herein, the terms “first,” “second,” and so on, do not necessarily denote any ordinal, sequential, or priority relation, but are simply used to more clearly distinguish one element or set of elements from another, unless specified otherwise.

Where used herein, the terms “viewer,” “operator,” “observer,” “wearer,” and “user” are considered equivalents and refer to the person or machine who wears and/or views images using a head mounted device.

Where used herein, the term “set” refers to a non-empty set, as the concept of a collection of elements or members of a set is widely understood in elementary mathematics. The term “subset,” unless otherwise explicitly stated, is used herein to refer to a non-empty proper subset, that is, to a subset of the larger set, having one or more members. For a set S, a subset may comprise the complete set S. A “proper subset” of set S, however, is strictly contained in set S and excludes at least one member of set S.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

Where used herein, the term “substantially” is intended to mean within the tolerance range of the equipment used to produce the value, or, in some examples, is intended to mean plus or minus 10%, or plus or minus 5%, or plus or minus 1%, unless otherwise expressly specified.

Where used herein, the term “exemplary” is intended to mean “an example of,” “serving as an example,” or “illustrative,” and does not denote any preference or requirement with respect to a disclosed aspect or embodiment.

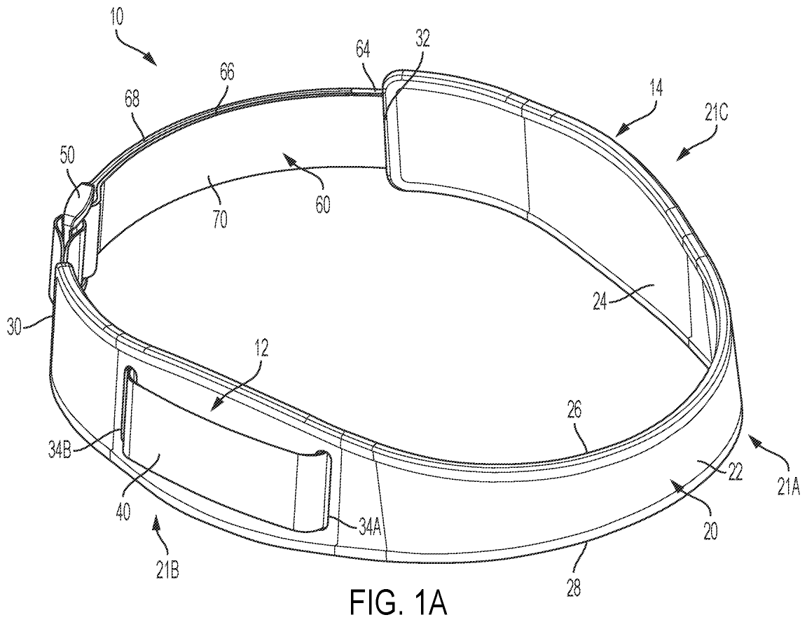

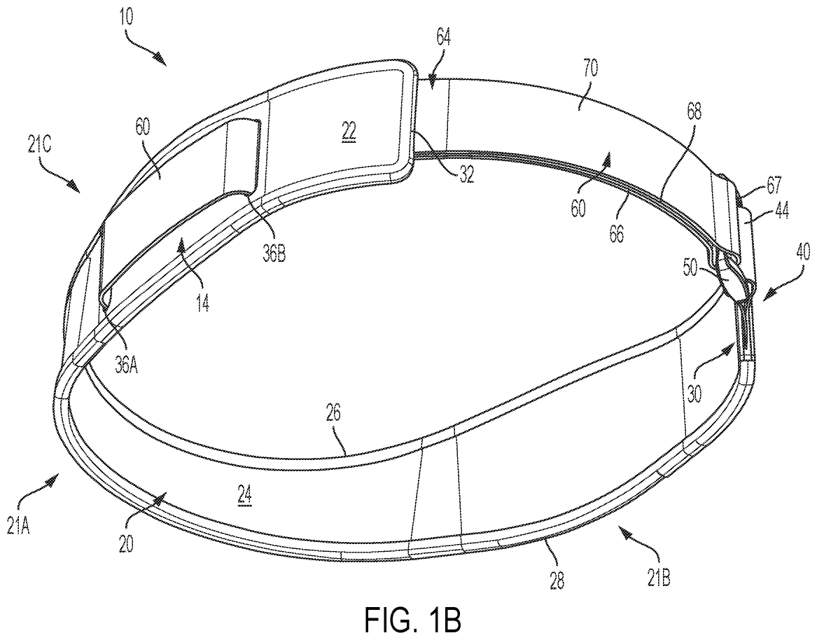

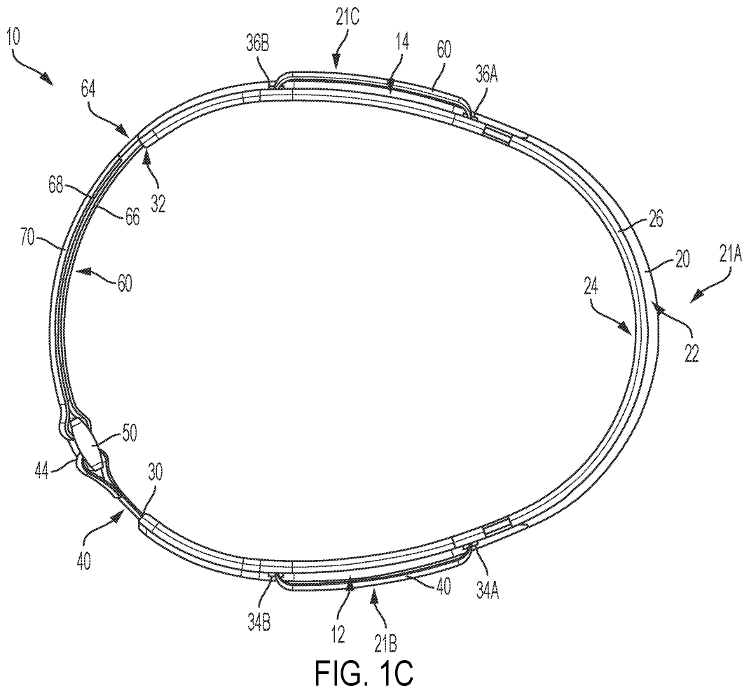

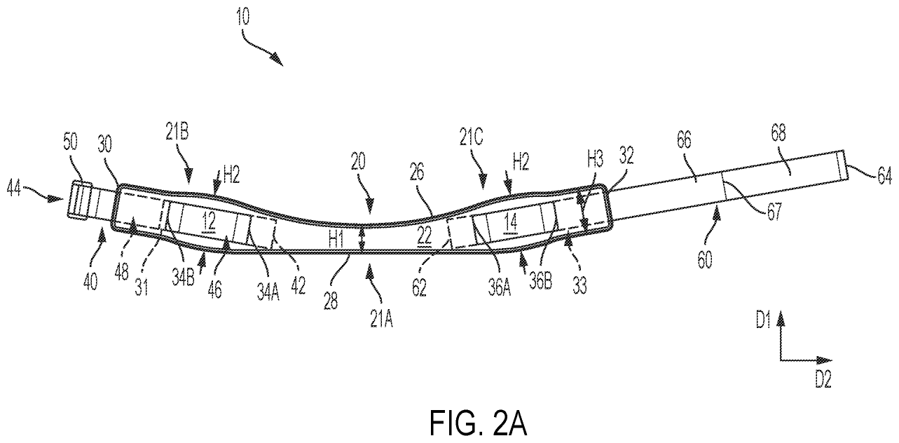

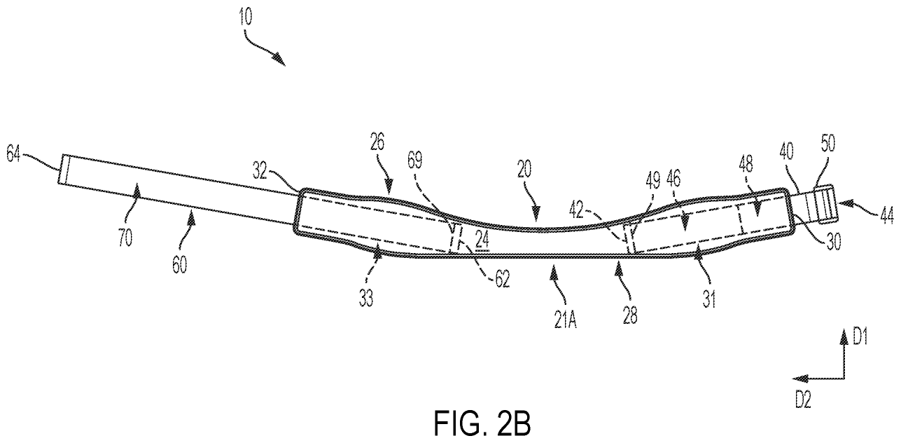

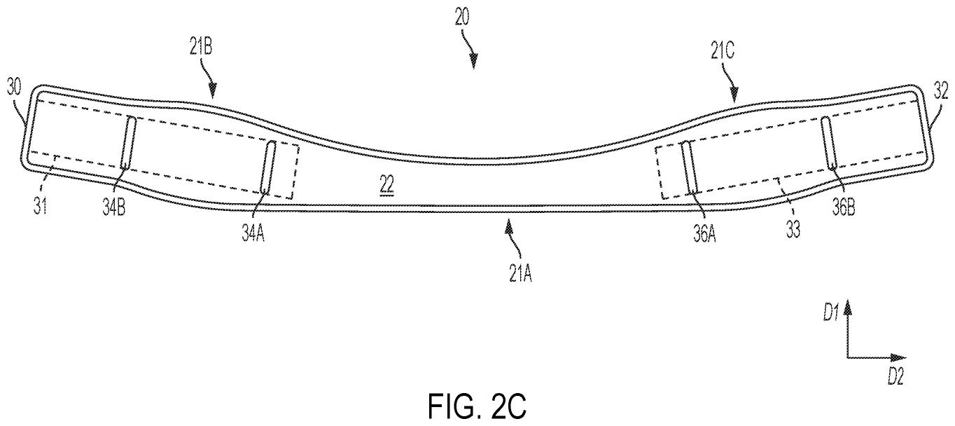

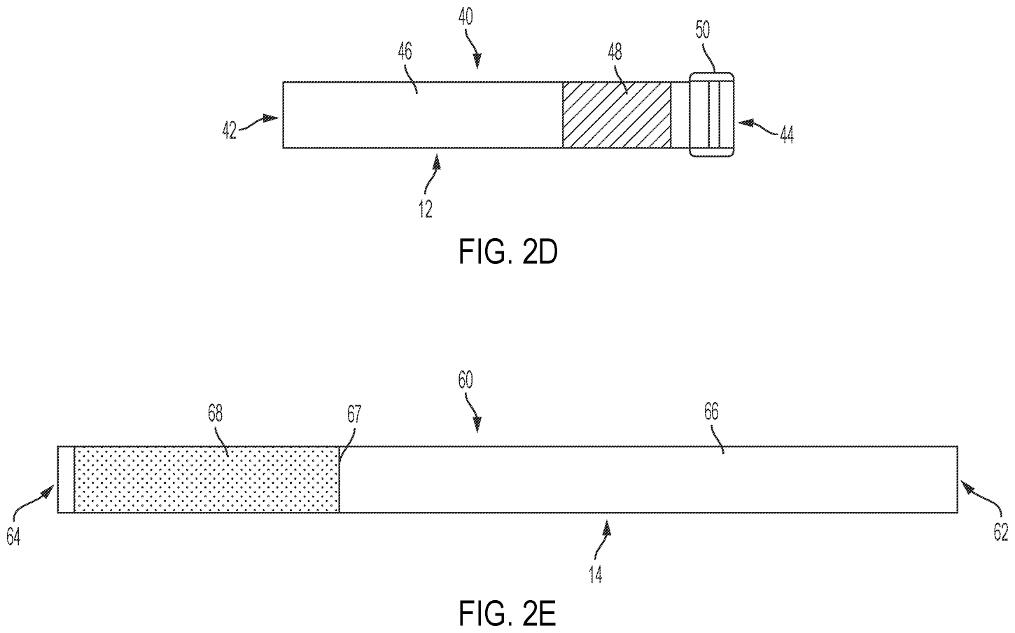

Adverting now to the figures, FIG. 1A is a top front perspective view of headband 10 in a secured state. FIG. 1B is a bottom rear perspective view of headband 10 in the secured state. FIG. 1C is a top elevational view of headband 10 in the secured state. FIG. 2A is a front elevational view of headband 10 in an unsecured state. FIG. 2A is a rear elevational view of headband 10 in the unsecured state. FIG. 2C is a front elevational view of a portion of headband 10, namely, strap 20. FIG. 2D is a rear elevational view of another portion of headband 10, namely, strap 40. FIG. 2E is a rear elevational view of still another portion of headband 10, namely, strap 60. Thus, as shown in at least FIGS. 1A-2E, headband 10 generally comprises strap 20, strap 40, and strap 60. In an exemplary embodiment, headband 10 further comprises connector or ring or loop 50.

Strap 20 comprises outer surface 22, inner surface 24, top 26, bottom 28, first end 30, and second end 32. Strap 20 is operatively arranged to engage at least a portion of a user's head, namely, the user's forehead and temples. Specifically, inner surface 24 is arranged against the user's head. In an exemplary embodiment, outer surface 22, inner surface 24, top 26, and bottom 28 form a passageway, therebetween creating one or more tubular members within which strap 40 and/or 60 are arranged (see FIGS. 2A-2B). For example, strap 20 may comprise a first layer forming outer surface 22 and a second layer forming inner surface 24, wherein the two pieces of material are connected along top 26 and bottom 28 (e.g., via stitching, adhesive, etc.). In an exemplary embodiment, a third layer wraps around and/or connects the first and second layers at top 26 and a fourth layer wraps around and/or connects the first and second layers at bottom 28 (e.g., via stitching, adhesive, etc.). For example, the third layer and/or the fourth layer may form a bound seam BSd, BSe, or BSh, which is a binding over the edge of two plies, namely, the first layer and the second layer. In an exemplary embodiment, the passageway extends completely through strap 20 from end 30 to end 32. In an exemplary embodiment, passageway 31, 33 extends partially through strap 20 from one of end 30 and end 32. In an exemplary embodiment, passageway 31 extends only partially through strap 20 from end 30 and passageway 33 extends only partially through strap 20 from end 32. For example, the passageways 31, 33 may not extend through the entire strap 20 because a forehead portion 21A (i.e., central portion) of the strap 20 may comprise only one layer of material or because the first and second layers of material are connected by, for example, stitching or adhesive in one or more locations between the ends 30, 32.

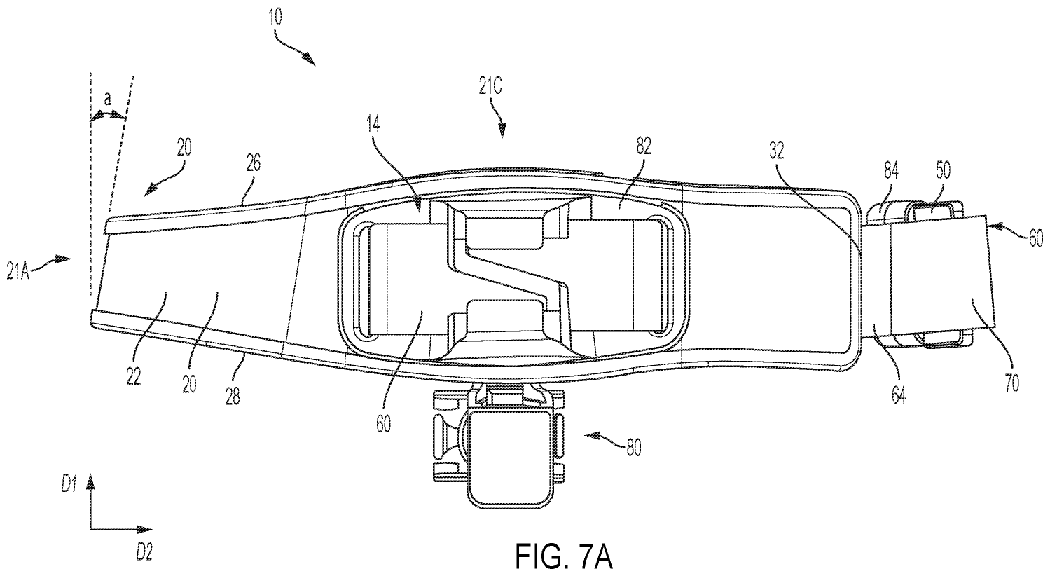

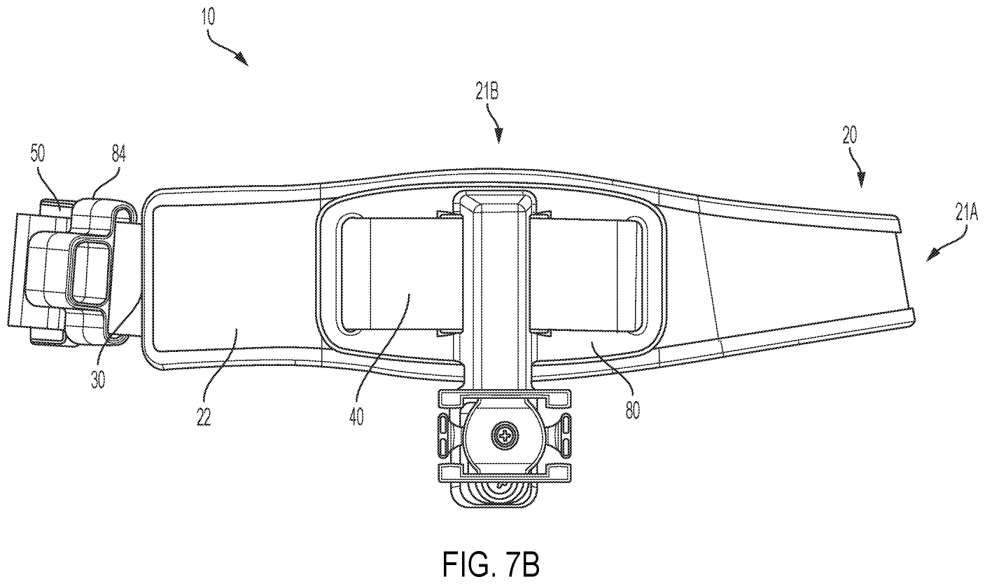

Strap 20 comprises forehead portion 21A, temple portion 21B, and temple portion 21C. Forehead portion 21A is arranged between temple portion 21B and temple portion 21C. Temple portion 21B is arranged between forehead portion 21A and end 30 of strap 20. Temple portion 21C is arranged between forehead portion 21A and end 32 of strap 20. In an exemplary embodiment, forehead portion 21A comprises height H1 and temple portion 21B and/or temple portion 21C comprises height H2, wherein height H2 is greater than height H1 (see FIG. 2A). In an exemplary embodiment, end 30 and/or end 32 comprises height H3, wherein height H3 is greater than thickness H1 and less than height H2. It should be appreciated that, in one or more exemplary embodiments, headband 10 can have a single uniform height, i.e., where forehead portion 21A, temple portion 21B, and temple portion 21C are all the same height. In an exemplary embodiment, and as best shown in FIG. 7A, when headband 10 is in the secured state, forehead portion 21A is arranged at angle α with respect to vertical direction D1. In an exemplary embodiment, angle α is an acute angle. In an exemplary embodiment, angle α is approximately 5°. These variations in height throughout strap 20 and/or the angular arrangement of forehead portion 21A in the secured state of headband 10 are arranged to matingly engage with the user's forehead and provides the user with the best possible securement and comfort.

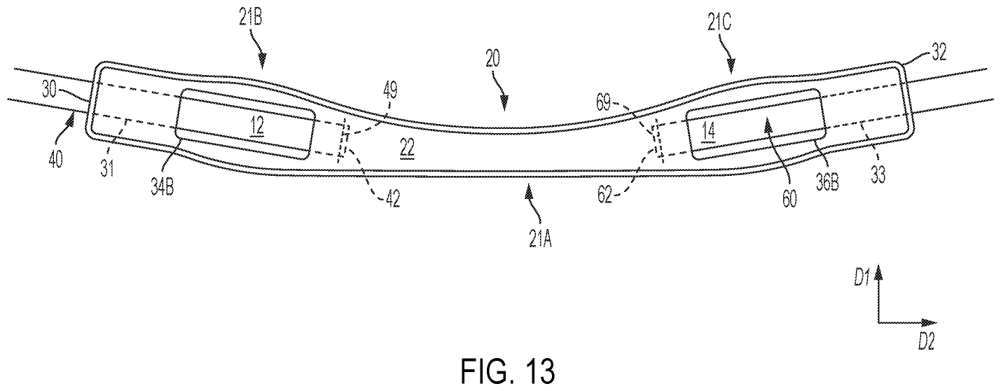

Strap 20 further comprises one or more openings 34A, 34B (shown best in FIG. 2C) arranged at or proximate to temple portion 21B. Opening 34A is arranged between forehead portion 21A and opening 34B, generally along horizontal direction D2. Opening 34B is arranged between opening 34A and end 30. In an exemplary embodiment, openings 34A and 34B are formed as a single opening by cutting one window into outer surface 22 (i.e., through the first layer). For example, and as shown in FIG. 13, window 34B forms two openings in strap 20. In an exemplary embodiment, as shown in FIG. 2C, opening 34A is formed by cutting a first hole into outer surface 22 and opening 34B is formed by cutting a second hole, spaced apart from the first hole, into outer surface 22. Openings 34A, 34B are operatively arranged to engage strap 40 to form loop 12, as will be described in greater detail below. It should be appreciated that in an exemplary embodiment, passageway 31 is formed through strap 20 from end 30 to a point between opening 34A and forehead portion 21A (e.g., end 42 as shown in FIG. 2C).

Strap 20 further comprises one or more openings 36A, 36B arranged at or proximate to temple portion 21C. Opening 36A is arranged between forehead portion 21A and opening 36B, generally along horizontal direction D2. Opening 36B is arranged between opening 36A and end 32. In an exemplary embodiment, openings 36A and 36B are formed as a single opening by cutting one window into outer surface 22 (i.e., through the first layer). For example, and as shown in FIG. 13, window 36B forms two openings in strap 20. In an exemplary embodiment, opening 36A is formed by cutting a first hole into outer surface 22 and opening 36B is formed by cutting a second hole, spaced apart from the first hole, into outer surface 22. Openings 36A, 36B are operatively arranged to engage strap 60 to form loop 14, as will be described in greater detail below. It should be appreciated that in an exemplary embodiment, passageway 33 is formed through strap 20 from end 32 to a point between opening 36A and forehead portion 21A (e.g., end 62 as shown in FIG. 2C).

In an exemplary embodiment, strap 20 comprises at least one of polyester, elastane (e.g., LYCRA® elastane), fabric, and polyester fiber. In an exemplary embodiment, top 26 and/or bottom 28 layers comprise synthetic polyester fiber or fabric, for example TERYLENE synthetic polyester fiber. In an exemplary embodiment, the layer forming outer surface 22 comprises polyester, LYCRA® synthetic elastic fiber, fabric, or a combination of thereof. For example, In an exemplary embodiment, the layer forming outer surface 22 comprises a first layer of polyester, a second layer of LYCRA® synthetic elastic fiber, and a third layer of fabric (e.g., approximately 0.08 mm in thickness). In an exemplary embodiment, the layer forming inner surface 24 comprises polyester, LYCRA® synthetic elastic fiber, styrene-butadiene rubber (SBR), fabric, or a combination of thereof. For example, in an exemplary embodiment, the layer forming inner surface 24 comprises a first layer of polyester, a second layer of LYCRA® synthetic elastic fiber, a third layer of styrene-butadiene rubber (SBR) (e.g., approximately 1.0 mm in thickness), and a fourth layer of fabric. In an exemplary embodiment, strap 20 is non-elastic. In an exemplary embodiment, at least a portion of strap 20 is operable to experience small elastic deformation.

Strap 40 comprises end 42 and end 44. End 44 is operatively arranged to be connected to strap 60. In an exemplary embodiment, end 42 is fixedly secured to strap 20. In an exemplary embodiment, end 42 is fixedly secured to strap 20 within passageway 31, at a point between opening 34A and forehead portion 21A, as best shown in FIG. 2A. It should be appreciated that strap 40 may be secured to strap 20 via any suitable means, for example, stitching 49 (shown in FIG. 2B), adhesives, etc. End 44 is arranged to extend out of passageway 31 beyond end 30. In an exemplary embodiment, end 44 is connected to connector 50. Strap 40 may be connected to connector 50 via any suitable means, for example, by looping end 44 around a portion of connector 50, stitching, adhesives, etc. In an exemplary embodiment, connector 50 comprises polyoxymethylene (POM) or acetal, polymer, or copolymer. Strap 40 is operatively arranged to engage both opening 34A and opening 34B such that a portion of strap 40, aligned with strap 20, is capable of extending radially outward of outer surface 22. This portion of strap 40 forms mounting loop 12.

In an exemplary embodiment, strap 40 is at least partially elastically deformable. For example, strap 40 comprises non-elastic portion 46 and elastic portion 48. In an exemplary embodiment, non-elastic portion 46 extends from end 42 to a position between opening 34B and end 30, thus providing a non-elastic mounting loop 12 with which to mount devices. Elastic portion 48 extends from non-elastic portion 46 (i.e., at a position between opening 34B and end 30) to end 44. Elastic portion 48 provides some elastic deformation (i.e., “give”) in headband 10 allowing for greater comfort to the user when headband 10 is in the secured state. Additionally, elastic portion 48 is arranged such that the amount of elastic deformation is not too great, i.e., not so elastic that devices attached to loop 12 will sag or rotate when mounted. In an exemplary embodiment, non-elastic portion 46 comprises polyester, LYCRA® synthetic elastic fiber, fabric, or a combination of thereof. For example, non-elastic portion 46 may comprise a first layer of polyester, a second layer of LYCRA® synthetic elastic fiber, and a third layer of fabric (e.g., approximately 0.08 mm in thickness). In another exemplary embodiment, strap 40 is completely elastic. In yet another exemplary embodiment, strap 40 is completely non-elastic.

Strap 60 comprises end 62 and end 64. End 64 is operatively arranged to be connected to strap 20. In an exemplary embodiment, end 64 is fixedly secured to strap 20. In an exemplary embodiment, end 62 is fixedly secured to strap 20 within passageway 33, at a point between opening 36A and forehead portion 21A, as best shown in FIG. 2A. It should be appreciated that strap 60 may be secured to strap 20 via any suitable means, for example, stitching 69, adhesives, etc. End 64 is arranged to extend out of passageway 33 beyond end 32. In an exemplary embodiment, end 64 is operatively arranged to be connected to connector 50, as will be described in greater detail below. Strap 60 is operatively arranged to engage both opening 36A and opening 36B such that a portion of strap 60, aligned with strap 20, is capable of extending radially outward of outer surface 22. This portion of strap 60 forms mounting loop 14. In an exemplary embodiment, loop 14 (i.e., the engagement of strap 60 and strap 20) forms a choker hitch.

In an exemplary embodiment, strap 60 (shown in FIG. 2E) comprises multiple layers or components. For example, strap 60 may comprise section 66 including one of hook fasteners and loop fasteners, and section 68 including the other of hook fasteners and loop fasteners. In an exemplary embodiment, sections 66 and 68 may be connected to layer 70. In such embodiment, layer 70 is a backing layer to which sections 66 and 68 are secured (i.e., strap 60 comprises section 66, section 68, and layer 70). Strap 60 is operatively arranged to be connected to connector 50 to secure headband 10 to a user's head. For example, in an exemplary embodiment, strap 60 is fed through connector 50 in a first direction and folded, for example along line 67, such that loop fastener section 68 can be secured to hook fastener section 66. This connection method allows headband 10 to be adjustably tightened based on the size of the user's head. It should be appreciated, however, that any means suitable for adjustably connecting strap 60 to strap 40 may be used, for example, one or more snaps, one or more clamps, a buckle, a ladder lock buckle, a connecting clip, etc.

In an exemplary embodiment, strap 60 is non-elastic. In an exemplary embodiment, strap 60 is at least partially elastic. In an exemplary embodiment, layer 70 comprises polyester, LYCRA® synthetic elastic fiber, thermoplastic polyurethane (TPU), or a combination of thereof. For example, layer 70 may comprise a first layer of polyester, a second layer of LYCRA® synthetic elastic fiber, and a third layer of TPU (e.g., 0.1 mm in height). In an exemplary embodiment, section 66 comprises hook fastener and section 68 comprises loop fastener. In an exemplary embodiment, section 66 comprises loop fastener and section 68 comprises hook fastener.

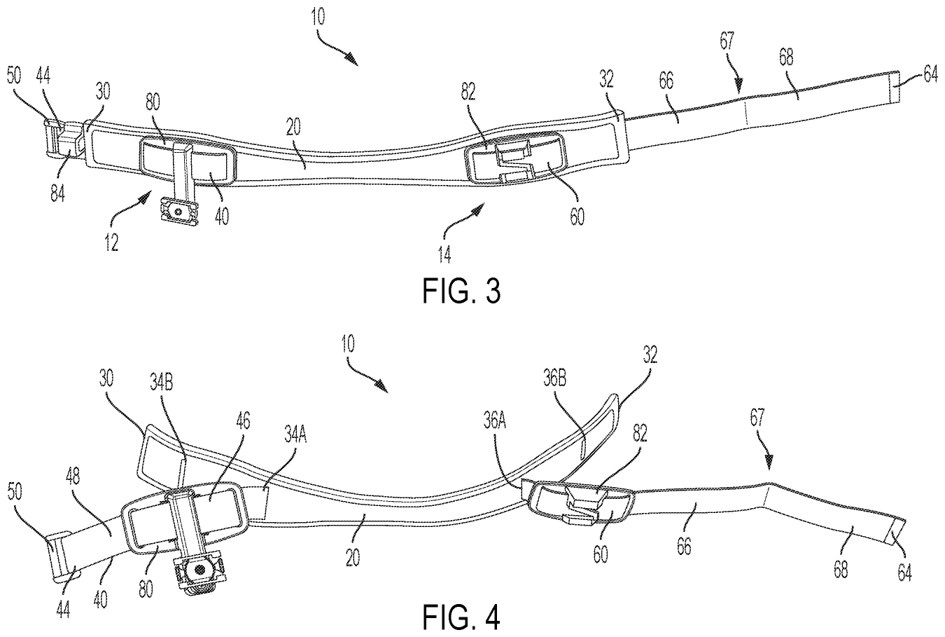

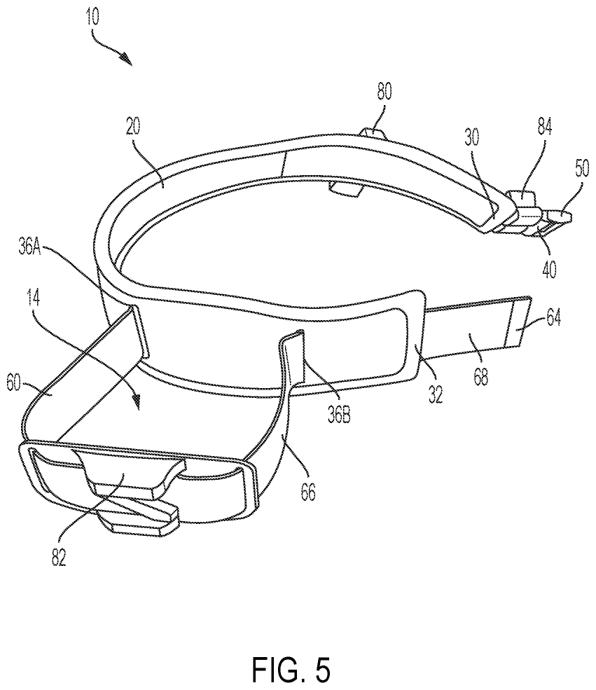

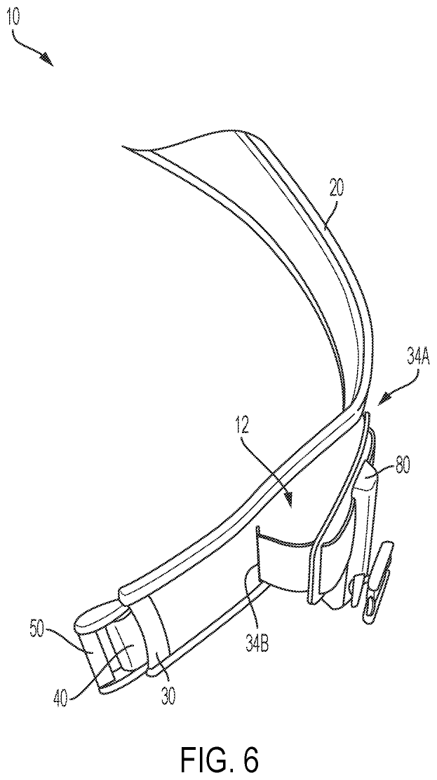

FIG. 3 is a top front perspective view of headband 10, in an unsecured state. FIG. 4 is a top front perspective view of headband 10, in a partial disassembled state. FIG. 5 is a top perspective view of headband 10, showing mounting loop 14 in a loosened state. FIG. 6 is a top perspective view of headband 10, showing loop 12 in a loosened state. In an exemplary embodiment, and as shown, headband 10 further comprises one or more brackets or clips, for example, clip 80, clip 82, and/or clip 84, operatively arranged to facilitate mounting or connection of devices to headband 10.

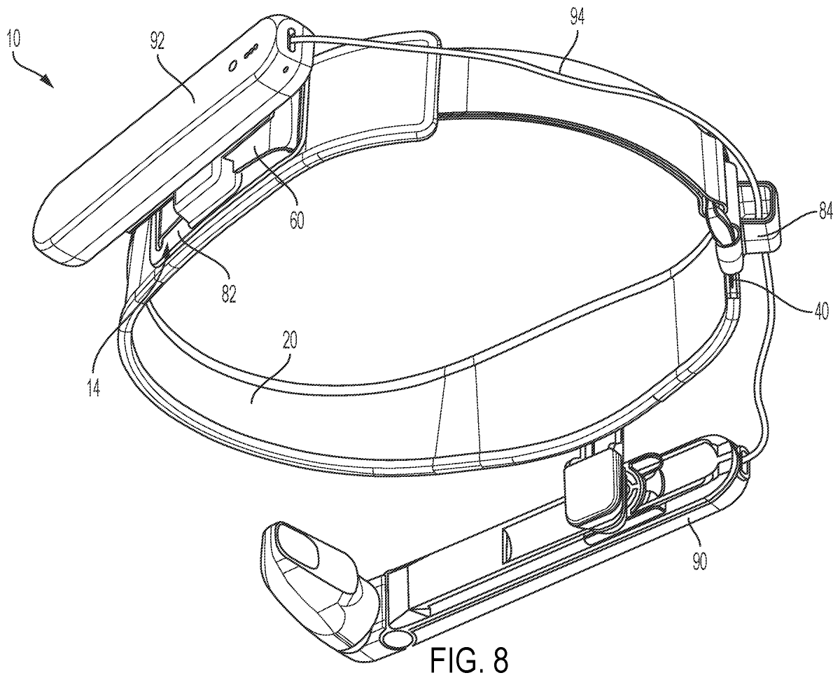

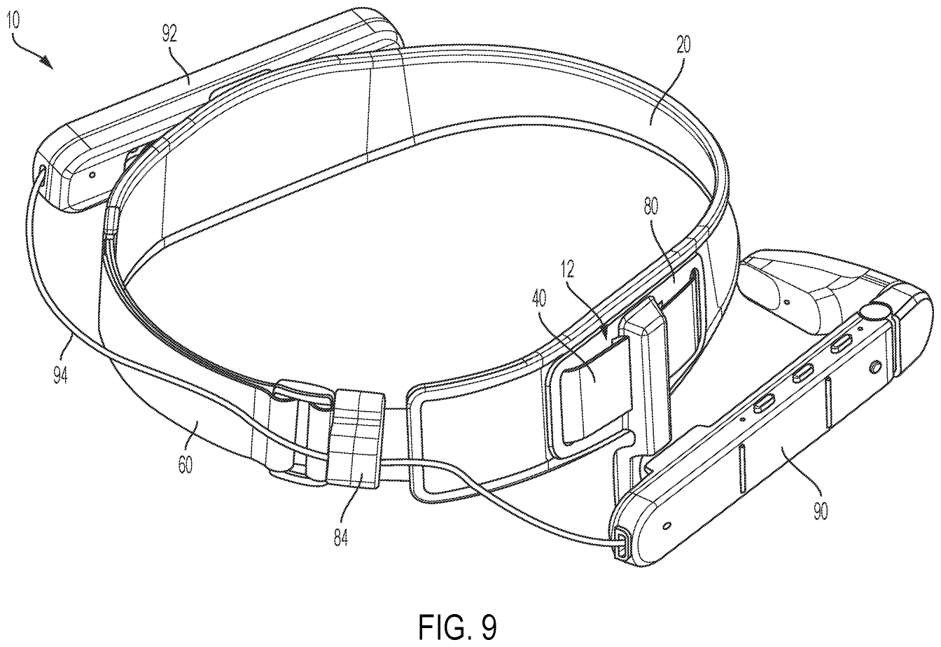

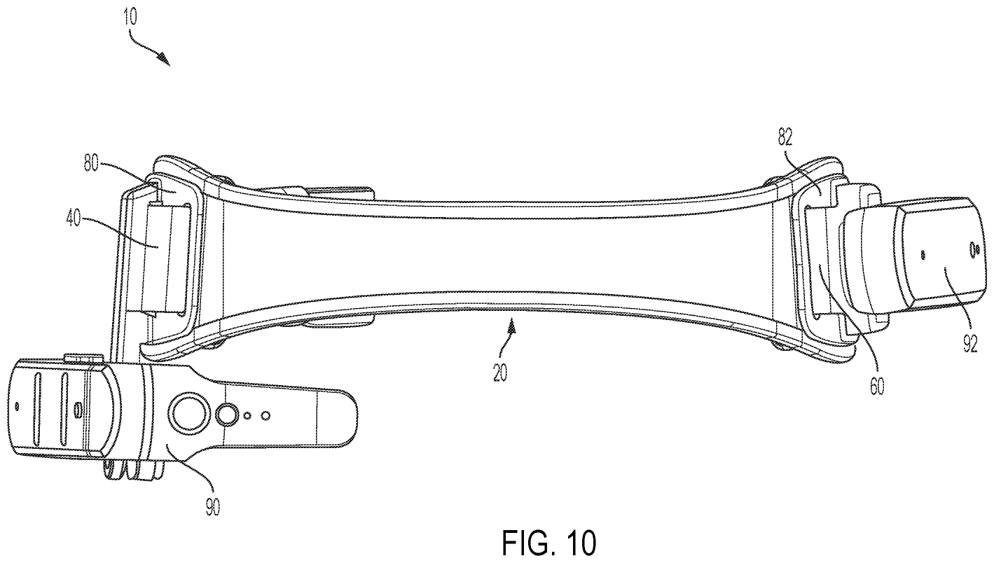

Clip 80 comprises an inner surface arranged to abut against strap 20, an outer surface, and one or more openings that engage strap 40 to connect clip 80 to strap 20. For example, clip 80 comprises a first opening and a second opening. In an exemplary embodiment, strap 40 is fed radially outward through the first opening and radially inward through the second opening to secure clip 80 to strap 20. In one example embodiment, and when assembled, the opening 34A aligns with the first opening of clip 80, and the opening 34B aligns with the second opening of clip 80, which operates to prevent clip 80 from moving relative to strap 20. In an exemplary embodiment, clip 80 comprises a connector operatively arranged to engage display 90, as shown in FIGS. 8-10. In an exemplary embodiment, display 90 is slidingly and/or pivotably connected to clip 80. As such, display 90 is mountable to headband 10, specifically strap 20, via clip 80 and strap 40. In an exemplary embodiment, display 90 may comprise one or more of the displays disclosed in U.S. Patent Application Publication No. 2020/0278555 (Porter et al.), which patent application publication is incorporated herein by reference in its entirety.

Clip 82 comprises an inner surface arranged to abut against strap 20, an outer surface, and one or more openings that engage strap 60 to connect clip 82 to strap 20. For example, clip 82 comprises a first opening and a second opening. In an exemplary embodiment, strap 60 is fed radially outward through the first opening and radially inward through the second opening to secure clip 82 to strap 20. In one example embodiment, and when assembled, the opening 36A aligns with the first opening of clip 82, and the opening 36B aligns with the second opening of clip 82, which operates to prevent clip 82 from moving relative to strap 20. In an exemplary embodiment, clip 82 comprises a connector, for example a slot, operatively arranged to engage battery 92, as shown in FIGS. 8-10. In an exemplary embodiment, battery 92 is slidingly and/or pivotably connected to clip 82. As such, battery 92 is mountable to headband 10, specifically strap 20, via clip 82 and strap 60.

Headband 10 may further comprise clip 84 operatively arranged to engage a cable or wire 94. For example, display 90 may be electrically connected to battery 92 via wire 94. Additionally or optionally, display 90 may be electrically connected to a peripheral device, e.g., a personal computer, laptop, smart phone, etc., via wire 94. Wire 94 may be routed around the user's head outside of headband 10. Wire 94 can be directed from battery 92 or other peripheral device, through clip 84, to display 90. It should be appreciated that while clip 84 is shown being connected to strap 40, specifically elastic portion 48, clip 84 can be connected to any other portion of headband 10, including but not limited to section 66 and/or section 68, or strap 20. In an exemplary embodiment, clip 84 comprises a loop portion arranged to engage wire 94, and a connecting portion arranged to secure the loop portion to strap 20, 40, 60. The loop portion is connected to the connecting portion. The connecting portion comprises a slot formed by two flanges generally directed in vertical direction D1. In an exemplary embodiment, a space is formed between the flanges to engage with strap 20, 40, 60.

To assemble headband 10, strap 40 is fed out of passageway 31 via opening 34A. End 44 is fed back into passageway 31 via opening 34B and out of strap 20 via end 30. Loop 12 is formed between strap 40 and strap 20. In an exemplary embodiment, and as shown in FIG. 4, before end 44 is fed back into passageway 31 via opening 34B, end 44 is fed through clip 80. For example, end 44 may be fed through a first opening of clip 80 and then through a second opening of clip 80. In an exemplary embodiment, end 44 is connected to connector 50. FIG. 6 shows loop 12 in a loosened state. As end 44 is pulled out of end 30, loop 12 closes and clamps clip 80 securely against strap 20. It should be appreciated that the clamping effect of loop 12 may be used for other devices, and not just clip 80 as shown.

Similarly, strap 60 is fed out of passageway 33 via opening 36A. End 64 is fed back into passageway 33 via opening 36B and out of strap 20 via end 32. Loop 14 is formed between strap 60 and strap 20. In an exemplary embodiment, and as shown in FIG. 4, before end 64 is fed back into passageway 33 via opening 36B, end 64 is fed through clip 82. For example, end 64 may be fed through a first opening of clip 82 and then through a second opening of clip 82. In an exemplary embodiment, end 64 is connected to connector 50 as previously described. FIG. 5 shows loop 14 in a loosened state. As end 64 is pulled out of end 32, loop 14 closes and clamps clip 82 securely against strap 20. It should be appreciated that the clamping effect of loop 14 may be used for other devices, and not just clip 82 as shown.

FIG. 7A is a left side elevational view of headband 10, in a secured state. FIG. 7B is a right side elevational view of headband 10, in a secured state. As shown, strap 60 is secured to strap 40 to form a secured state of headband 10. It should be appreciated that when strap 20 is tightened to the user's head, for example via the engagement of strap 60 with strap 40 via connector 50, headband 10 tightens around the user's head and loops 12 and 14 tighten to secure clips 80 and 82 securely against strap 20.

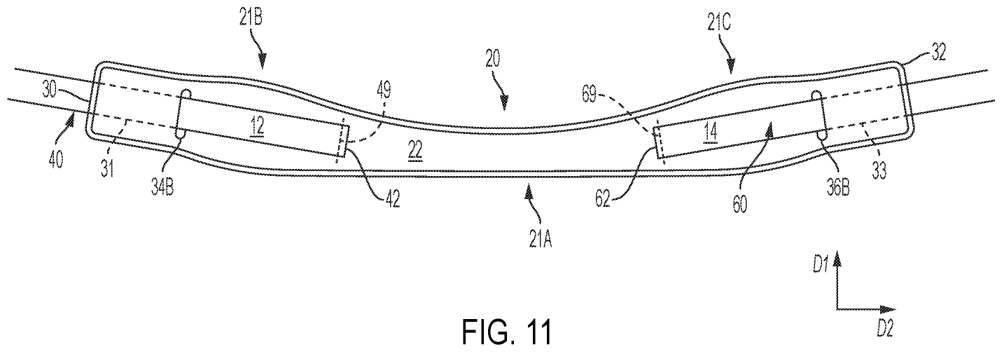

FIG. 11 is a front elevational view of a portion of headband 10 according to an exemplary embodiment of the presently disclosed subject matter. As shown, in some embodiments strap 20 comprises first opening 34B and second opening 36B. First passageway 31 extends between end 30 and first opening 34B, and second passageway 33 extends between end 32 and second opening 36B. Strap 40 engages passageway 31 and is fixedly secured to strap 20. For example, end 42 of strap 40 is fed into passageway 31 through end 30, out of passageway 31 through opening 34B, and is secured to outer surface 22 or inner surface 24 (e.g., via stitching 49). The portion of strap 40 arranged between stitching 49 and opening 34B forms loop 12. Strap 60 engages passageway 33 and is fixedly secured to strap 20. For example, end 62 of strap 60 is fed into passageway 33 through end 32, out of passageway 33 through opening 36B, and is secured to outer surface 22 or inner surface 24 (e.g., via stitching 69). The portion of strap 60 arranged between stitching 49 and opening 36B forms loop 14.

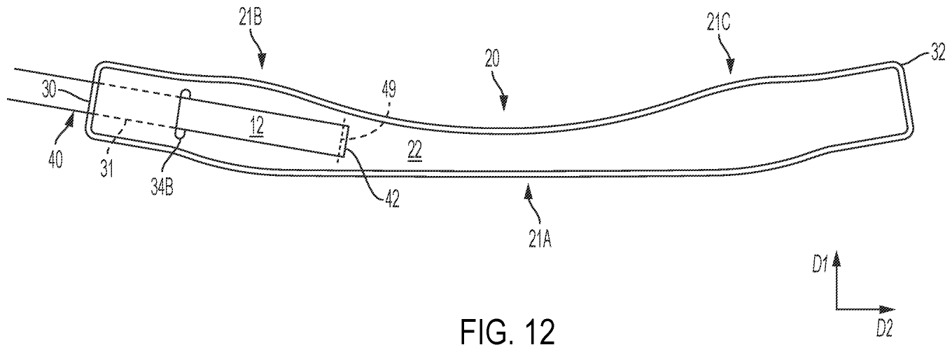

FIG. 12 is a front elevational view of a portion of headband 10 according to an exemplary embodiment of the presently disclosed subject matter. As shown, in some embodiments, headband 10 comprises two straps, for example, strap 20 and strap 40. Strap 20 may comprise one or more openings, for example, opening 34B. First passageway 31 extends between end 30 and opening 34B. Strap 40 engages passageway 31 and is fixedly secured to strap 20. For example, end 42 of strap 40 is fed into passageway 31 through end 30, out of passageway 31 through opening 34B, and is secured to outer surface 22 or inner surface 24 (e.g., via stitching 49). The portion of strap 40 arranged between stitching 49 and opening 34B forms loop 12. End 44 (not shown) of strap 40 is operatively arranged to be connected to end 32 to form a secured state of headband 50, for example via a clip (e.g., clip 50), snap, buckle, loop, hook and loop fastener, or the like.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. A headband, comprising:
a first strap, including:
a first end comprising a first passageway;
a second end comprising a second passageway;
a first opening arranged on, in, along, or proximate to the first end; and
a second opening arranged on, in, along, or proximate to the second end;
a second strap connected to the first strap, the second strap arranged at least partially through the first passageway and the first opening; and
a third strap connected to the first strap, the third strap arranged at least partially through the second passageway and the second opening;
wherein the third strap is operatively arranged to selectively connect to the second strap.

2. The headband as recited in claim 1, wherein the first strap further comprises a first temple portion, a second temple portion, and a forehead portion arranged between the first temple portion and the second temple portion, wherein the first opening is arranged on, in, along, or proximate to the first temple portion.

3. The headband as recited in claim 2, wherein the first passageway and the second passageway are connected forming a single passageway.

4. The headband as recited in claim 2, wherein the forehead portion comprises a first height, the first temple portion comprises a second height, and the first height is less than the second height.

5. The headband as recited in claim 1, wherein the second strap comprises a third end fixedly secured to the first strap, and a fourth end.

6. The headband as recited in claim 5, wherein the third end is arranged in the first passageway.

7. The headband as recited in claim 5, wherein the fourth end is connected to a connector.

8. The headband as recited in claim 1, wherein a portion of the second strap engaged with the first opening forms a first loop.

9. The headband as recited in claim 8, wherein the first loop is movable between a loosened state and a tightened state.

10. The headband as recited in claim 8, wherein a portion of the third strap engaged with the second opening forms a second loop.

11. The headband as recited in claim 1, wherein the second strap comprises an elastic portion, and a non-elastic portion.

12. The headband as recited in claim 11, wherein the non-elastic portion is engaged with the first opening.

13. The headband as recited in claim 1, wherein the third strap comprises a hook fastener section, and a loop fastener section.

14. The headband as recited in claim 1, further comprising at least one clip arranged on at least one of the second strap and the third strap, the at least one clip operatively arranged to slidingly or pivotably secure an electronic device to the headband.

15. A headband for mounting one or more electronic devices, comprising:
a first strap, including:
a first end comprising a first passageway;
a second end comprising a second passageway;
a first opening arranged on, in, along, or proximate to the first end; and
a second opening arranged on, in, along, or proximate to the second end;
a second strap including a third end and a fourth end, the third end fixedly secured to the first strap, the second strap arranged at least partially through the first passageway and the first opening to form a first loop; and
a third strap including a fifth end and a sixth end, the fifth end fixedly secured to the first strap, the third strap arranged at least partially through the second passageway and the second opening to form a second loop;
wherein the third strap is operatively arranged to be adjustably connected to the second strap to form a secured state of the headband.

16. The headband as recited in claim 15, wherein the first strap further comprises a first temple portion, a second temple portion, and a forehead portion arranged between the first temple portion and the second temple portion, wherein the first opening is arranged on, in, along, or proximate to the first temple portion and the second opening is arranged on, in, along, or proximate to the second temple portion.

17. The headband as recited in claim 15, wherein the second strap is slidingly engaged with the first passageway to move the first loop between a first loosened state and a first tightened state.

18. The headband as recited in claim 17, wherein the third strap is slidingly engaged with the second passageway to move the second loop between a second loosened state and a second tightened state.

19. The headband as recited in claim 15, wherein the second strap comprises a non-elastic portion arranged proximate the third end, and an elastic portion arranged proximate the fourth end.

20. The headband as recited in claim 19, wherein the elastic portion extends out of the first passageway past the first end.
